(19) United States
(12) Patent Application Publication
(10) Pub. No.: US 2015/0033121 A1
(43) Pub. Date: Jan. 29, 2015

(54) MOTION BASED FILTERING OF CONTENT ELEMENTS

(71) Applicant: Disney Enterprises, Inc., Burbank, CA (US)

(72) Inventor: SYLVIA PARK-EKECS, Newbury Park, CA (US)

(73) Assignee: Disney Enterprises, Inc., Burbank, CA (US)

(21) Appl. No.: 13/952,507

(22) Filed: Jul. 26, 2013

(51) Int. Cl. G06F 3/0484; G06F 3/0482; G06F 3/16; G06F 3/01; G06F 3/0488

(52) U.S. Cl. CPC G06F 3/04845; G06F 3/017; G06F 3/0488; G06F 3/167; G06F 3/0482; G06F 3/016
USPC 715/702; 715/765

(57) ABSTRACT

Apparatus, systems, and methods disclosed herein include apparatus, systems, and methods for providing action-based filtering of content elements in an electronic content library. A disclosed method comprises displaying an electronic content library, receiving an action from a user as an input, performing an operation on the electronic content library based on the user action input to yield a revised electronic content library, displaying the revised electronic content library, and saving the revised electronic content library for future access. A variety of action input devices may be implemented to receive a variety of different action inputs, including, but not limited to, motion-based inputs, touch-based inputs, visual inputs, or audio inputs.

### TECHNICAL FIELD

The present disclosure relates generally to user interfaces, and, more particularly, to a user interface directed towards motion-based filtering of content elements.

### DESCRIPTION OF THE RELATED ART

User interfaces (UI) are essential in today's products to present users with an intuitive, entertaining way in which to access their electronic content. Traditional computer graphic user interfaces (GUIs) have generally utilized some sort of pull-down or drop-down menu. Modern devices have evolved to provide a variety of opportunities for user interface customization. These devices often include visual interfaces (e.g. displays and screens), audio outputs (e.g., speakers), motion-based inputs (e.g., accelerometers, cameras), touch-based inputs (e.g., touchscreens), in addition to more traditional input methods (e.g., keyboard, mouse, remote control, button inputs).

### BRIEF SUMMARY OF THE DISCLOSURE

According to various embodiments, the apparatus, systems, and methods described herein provide users with a user interface utilizing motion-based filtering of content elements.

In a first embodiment, a method for interacting with an electronic content library comprises displaying on a display at least a portion of the electronic content contained in the electronic content library; receiving via a user input device a user action as an input; performing a corresponding operation on the electronic content library based on the user action input to yield a revised electronic content library; and displaying the revised electronic content library on the display.

In one aspect of this embodiment, the user input device may comprise a motion sensor. The motion sensor may comprise a gyroscope and/or an accelerometer. In a further aspect of this embodiment, when the user action received as an input comprises a shaking action, the corresponding operation performed on the electronic content library may be a shuffling operation such that the revised electronic content library displayed on the display is a shuffled electronic content library. In yet another aspect of this embodiment, when the user action received as an input comprises a directional tilting action in a pre-determined direction, the corresponding operation performed on the electronic content library may be a filtering operation such that the revised electronic content library displayed on the display is a filtered subset of the electronic content library.

In another aspect of this embodiment, the user input device may comprise a touch sensor. The touch sensor may comprise a touch-sensitive surface, which may be a touch-sensitive display. In a further aspect, when the user action received as an input comprises a swirling motion on the touch sensor, the corresponding operation performed on the electronic content library may comprise a shuffling operation such that the revised electronic content library displayed on the display is a shuffled electronic content library. In another aspect, when the user action received as an input comprises a directional swipe in a predetermined direction, the corresponding operation performed on the electronic content library may be a filtering operation such that the revised electronic content library displayed on the display is a filtered subset of the electronic content library.

In another aspect of this embodiment, the user input device may comprise a visual sensor. The visual sensor may comprise a light sensor and/or a camera. In a further aspect, when the user action received as an input comprises a swirling motion captured by the visual sensor, the corresponding operation performed on the electronic content library may comprise a shuffling operation such that the revised electronic content library displayed on the display is a shuffled electronic content library. In another aspect, when the user action received as an input comprises a directional swipe in a predetermined direction, the corresponding operation performed on the electronic content library may be a filtering operation such that the revised electronic content library displayed on the display is a filtered subset of the electronic content library.

In another aspect of this embodiment, the user input device may comprise an audio sensor, which may comprise a microphone.

The present disclosure may also be embodied in a non-transitory computer readable medium comprising an instruction set configured to cause a computing device to perform the disclosed method described above.

The present disclosure may also be embodied in an electronic content interaction system comprising a display, an action input device, and a memory. The memory might be used to store an electronic content library and user action input interaction information. When the display is displaying at least a portion of the electronic content library, a user can perform an action using the action input device to interact with the electronic content library. A particular action performed on the action input device results in a pre-determined interaction with the electronic content library. The pre-determined interaction with the electronic content library results in display of a revised electronic content library on the display. The action input device may comprise one or more of a motion sensor, a touch sensor, a visual sensor, and/or an audio sensor. Particular pre-determined action inputs may result in shuffling of the electronic content library or filtering of the electronic content library.

Other features and aspects of the disclosure will become apparent from the following detailed description, taken in conjunction with the accompanying drawings, which illustrate, by way of example, the features in accordance with various implementations.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the disclosure. For clarity and ease of illustration, these drawings are not necessarily to scale.

FIG. 1 illustrates a tablet-style computing device equipped with motion-based content filtering, in accordance with an embodiment of the present disclosure.

FIG. 2 illustrates a computing module that may be used to implement various features of embodiments of the systems, apparatus, and methods described herein.

FIG. 3 provides a method flowchart for an action-based electronic content library revision method, in accordance with an embodiment of the present disclosure.

FIG. 4 illustrates a personal computer equipped with motion-based content filtering, in accordance with an embodiment of the present disclosure.

FIG. 5 illustrates a home entertainment system equipped with motion-based content filtering, in accordance with an embodiment of the present disclosure.

FIG. 6 illustrates the table-style computing device of claim 1 receiving movement-based user inputs, in accordance with an embodiment of the present disclosure.

### DETAILED DESCRIPTION

The disclosure provided herein describes apparatus, systems, and methods for providing motion-based filtering of content elements in an electronic content library. Growing competition in user-interface-centric products in combination with growing electronic content libraries may inspire newer, more innovative ways for users to interact with, filter, sort, select, and view their electronic content.

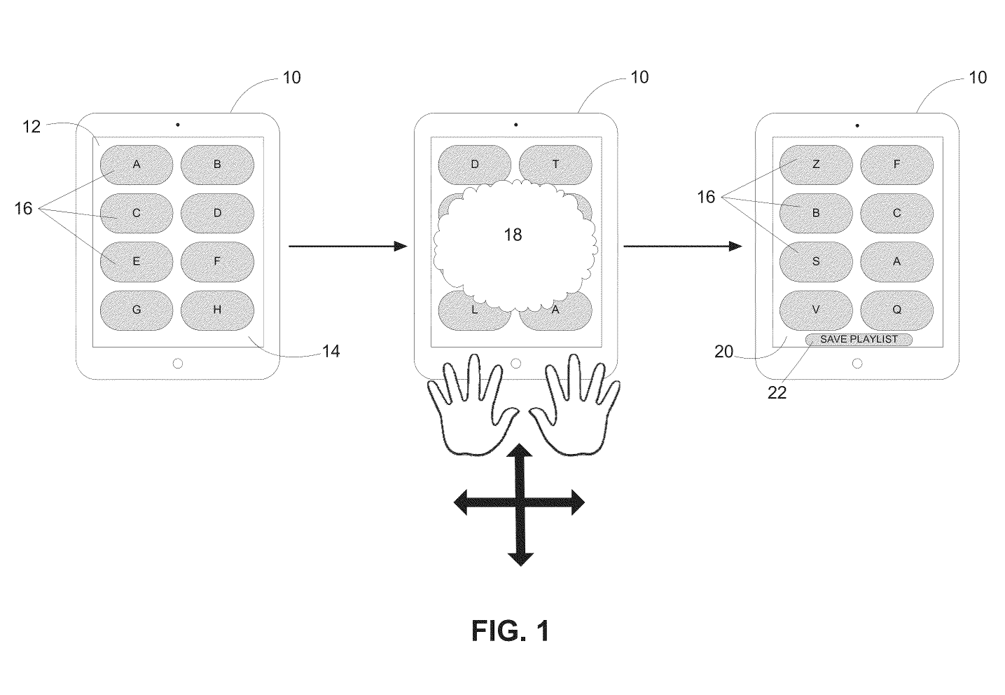

FIG. 1 presents an example of motion-based content filtering implemented on a computing device 10, in accordance with an embodiment of the present disclosure. The computing device 10 depicted in FIG. 1 is a tablet-style device. However, it should be understood, as will be explained in greater detail later on, that the present disclosure may be implemented on a wide variety of computing devices, including, but not limited to, tablets, smart phones, personal computers, laptops, televisions, entertainment systems, gaming systems, and the like. The tablet computing device 10 in FIG. 1 comprises a display 12 that is displaying a content library 14, the content library 14 comprising a plurality of content elements 16.

The content elements 16 may be any electronic content that can be catalogued digitally. This may include, but is not limited to, music, videos, pictures, documents, news articles, ebooks, computing files, and the like. The content library 14 may be any collection or catalog of a plurality of content elements 16 such that the content elements are presented for viewing and selection by a user.

In FIG. 1, a portion of a content library 14 with a plurality of content elements 16 is displayed to a user. The user may want to revise the content library 14 so that the content library 14 is filtered, re-ordered or sorted in some alternative way. In FIG. 1, the user wishes to shuffle the electronic content library 14 to randomize the order of the content elements 16. The tablet style computing device 10 may store user interaction information such that particular user interactions result in pre-determined operations being performed on the content library 14. For example, in FIG. 1, the user action of shaking the tablet style computing device 10 results in shuffling of the content library 14. The tablet style computing device 10 may include a motion sensor to detect the shaking action, such as a gyroscope and/or an accelerometer. When the tablet style computing device 10 detects the shaking action, it begins performing the corresponding operation on the content library 14 and shuffles its contents. An animation 18 may be displayed on the screen to indicate that the operation is being performed. For example, the animation 18 might comprise the content elements 16 moving around randomly in response to the user's shaking of the tablet style computing device 10.

Once the user stops shaking the computing device 10, a revised content library 20 is displayed to the user with the content elements 16 shuffled in a new, randomized order. The user may then be presented with an option to save the revised content library 20 for future access. In FIG. 1, this option is presented with a “Save Playlist” button 22.

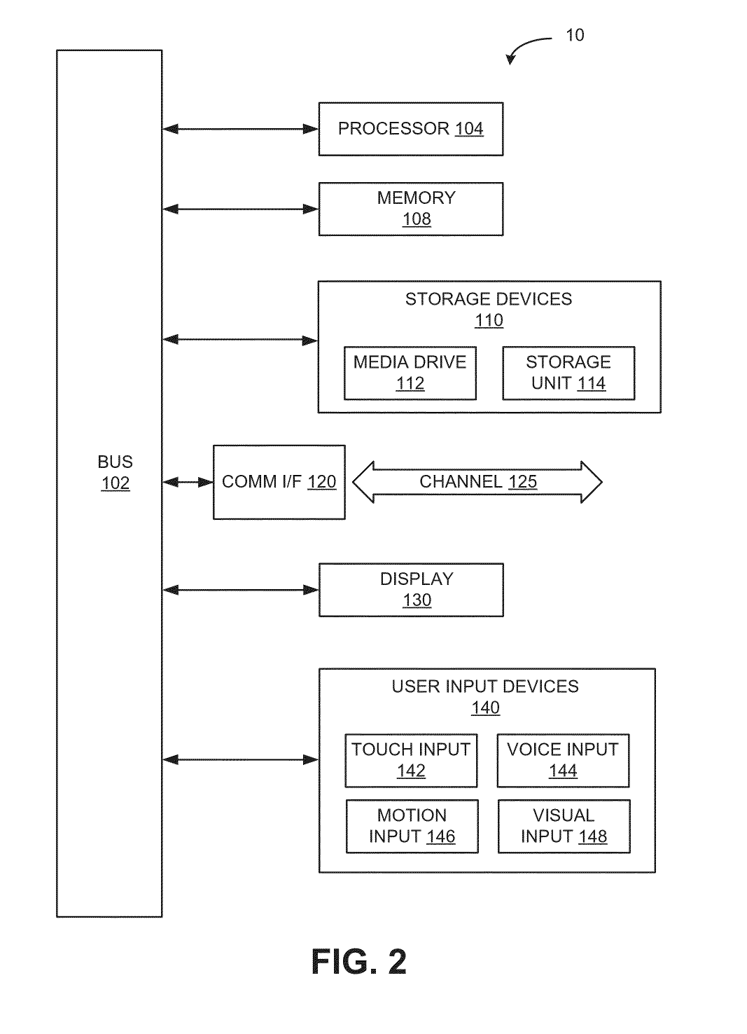

Components or modules of the action-based content filtering methods described herein may be implemented on a computing device 10 in whole or in part using software. In one embodiment, these software elements can be implemented to operate with a computing or processing module capable of carrying out the functionality described with respect thereto. One such example computing module is shown in FIG. 2. Various embodiments are described in terms of this example-computing module 10. After reading this description, it will become apparent to a person skilled in the relevant art how to implement the disclosure using other computing modules or architectures.

Referring now to FIG. 2, computing module 10 may represent, for example, computing or processing capabilities found within desktop, laptop and notebook computers; hand-held computing devices (PDA's, smart phones, tablets, cell phones, palmtops, etc.); mainframes, supercomputers, workstations or servers; entertainment systems, gaming systems, televisions, tablet devices, or any other type of special-purpose or general-purpose computing devices as may be desirable or appropriate for a given application or environment. Computing module 10 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 10 might include, for example, one or more processors, controllers, control modules, or other processing devices, such as a processor 104. Processor 104 might be implemented using a general-purpose or special-purpose processing engine such as, for example, a microprocessor, controller, or other control logic. In the illustrated example, processor 104 is connected to a bus 102, although any communication medium can be used to facilitate interaction with other components of computing module 10 or to communicate externally.

Computing module 10 might also include one or more memory modules, simply referred to herein as main memory 108. For example, random access memory (RAM) or other dynamic memory might be used for storing information and instructions to be executed by processor 104. Main memory 108 might also be used for storing temporary variables or other intermediate information during execution of instructions to be executed by processor 104. Computing module 10 might likewise include a read only memory (“ROM”) or other static storage device coupled to bus 102 for storing static information and instructions for processor 104.

The computing module 10 might also include one or more various forms of information storage mechanism 110, which might include, for example, a media drive 112 and a storage unit 114. The media drive 112 might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive 112. As these examples illustrate, the storage media can include a computer usable storage medium having stored therein computer software or data.

In alternative embodiments, information storage mechanism 110 might include other similar instrumentalities for allowing computer programs or other instructions or data to be loaded into computing module 10. Such instrumentalities might include, for example, a fixed or removable storage unit 114. Examples of such storage units 114 can include a program cartridge and cartridge interface, a removable memory (for example, a flash memory or other removable memory module) and memory slot, a PCMCIA slot and card, and other fixed or removable storage units 114 and interfaces that allow software and data to be transferred from the storage unit 114 to computing module 10.

Computing module 10 might also include a communications interface 120. Communications interface 120 might be used to allow software and data to be transferred between computing module 10 and external devices. Examples of communications interface 120 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 120. These signals might be provided to communications interface 120 via a channel 125. This channel 125 might carry signals and might be implemented using a wired or wireless communication medium. Some examples of a channel might include a phone line, a cellular link, an RF link, an optical link, a network interface, a local or wide area network, and other wired or wireless communications channels.

Computing module 10 might also include a display 130 for presenting information to and interacting with a user. The display may be any display appropriate for presenting electronic content to a user. Some examples might include an LCD display, a plasma display, a CRT monitor, an LED display, television sets, digital or analog projectors, displays on tablet devices, personal computers laptops, entertainment systems, retina displays, laser displays, and the like.

Computing module 10 might also include user input devices 140 for receiving interactive inputs from a user. One example of a user input device 140 might be a touch-based input 142. Touch-based input 142 might include keyboards, mice, touch-sensitive trackpads, touchscreen displays, remote controllers, gaming controllers, or any other input device that is able to receive a user command via touch or pressure sensitivity. User input device 140 may also include a motion input sensor 146. Examples of a motion input sensor 146 may include gyroscopes or accelerometers, or any other devices capable of sensing speed, acceleration, direction, or any other aspect of motion. Visual input sensors 148 such as cameras, light sensors, or proximity sensors may also be used as input devices. Voice input sensors 144 may also be utilized, such as a microphone.

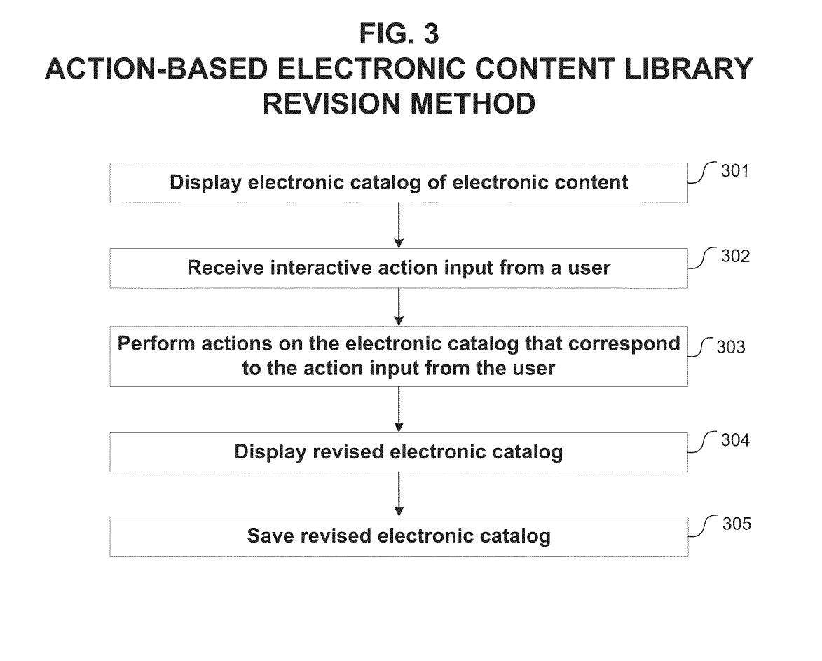

The present disclosure may be embodied in a method for implementing action-based electronic content library revision. A flowchart for one embodiment of such a method is presented in FIG. 3. In step 301, an electronic catalog or library containing a plurality of electronic content is displayed. In step 302, an interactive action input is received from the user. As discussed above, such interactive inputs may be received via numerous different user input devices. Such devices might include, but are not limited to, motion sensors, touch/pressure sensors, audio sensors, and/or visual sensors. In step 303, an operation corresponding to the received interactive action input is performed on the electronic content catalog. The operation performed on the electronic content catalog results in a revised electronic catalog, which is displayed to the user in step 304. Finally, the revised electronic catalog may be stored for future access in step 305.

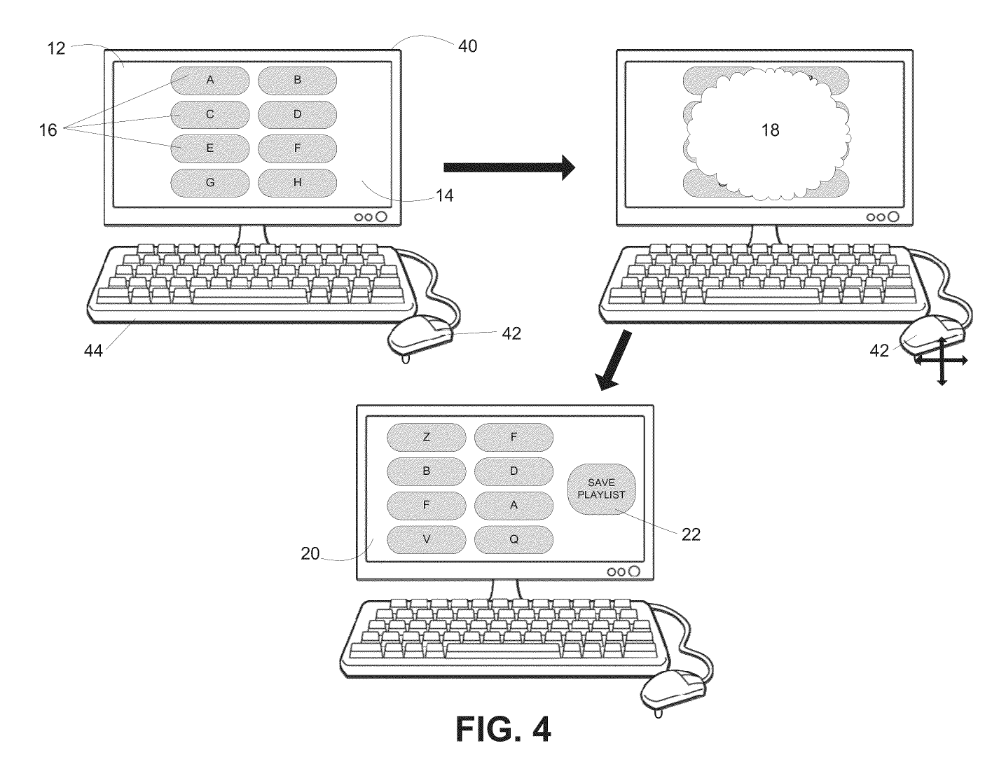

As was discussed above, although FIG. 1 discussed implementation of motion-based content filtering on a tablet device, the disclosed content filtering may also be implemented on other computing devices. In FIG. 4, the motion-based shuffle method discussed in FIG. 1 is implemented on a personal computer 40. The personal computer 40 comprises input devices such as a mouse 42 and a keyboard 44 and displays an electronic content library 12 with a plurality of content elements 16. If the user wishes to shuffle the contents 16 of electronic content library 12, the user may perform a particular action via the input devices 42, 44 that is associated with the desired operation. For example, in FIG. 4, the user might press a key on the keyboard (e.g., the Shift key) and simultaneously shake the mouse 42 while the electronic content library 12 is being displayed. When the computer 40 detects an action input by the user that corresponds to a particular operation, the computer 40 will perform the operation on the electronic content library 12. While the operation is being performed or while the user action is taking place, an animation 18 may be displayed on the display to indicate that the procedure is being performed. When the procedure is completed, a revised electronic content library 20 (in this case, a shuffled content library) is displayed, and may be saved for future access via option button 22.

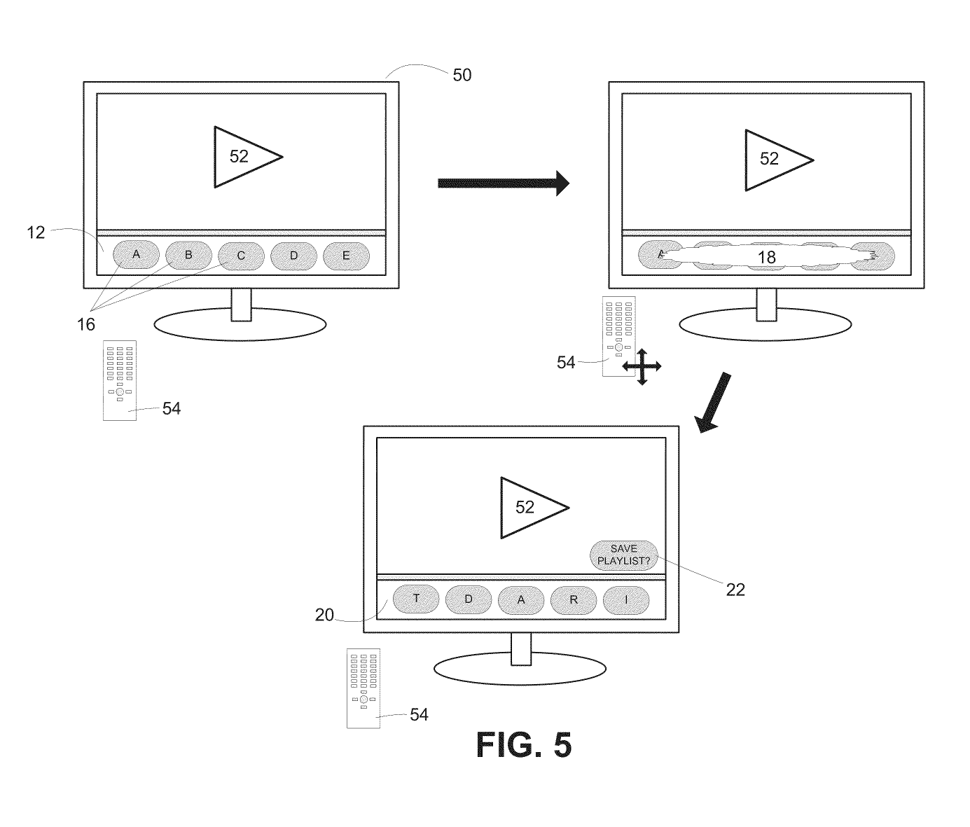

A similar operation is displayed in FIG. 5 using a television set 50. The television set 50 may include a secondary device 54 (e.g., a remote control) to provide a user input. The secondary device 54 might include multiple user inputs devices, such as a motion sensor (e.g., gyroscope or accelerometer), a voice sensor (e.g., microphone), touch sensor (e.g., push buttons), or a visual sensor (e.g., camera).

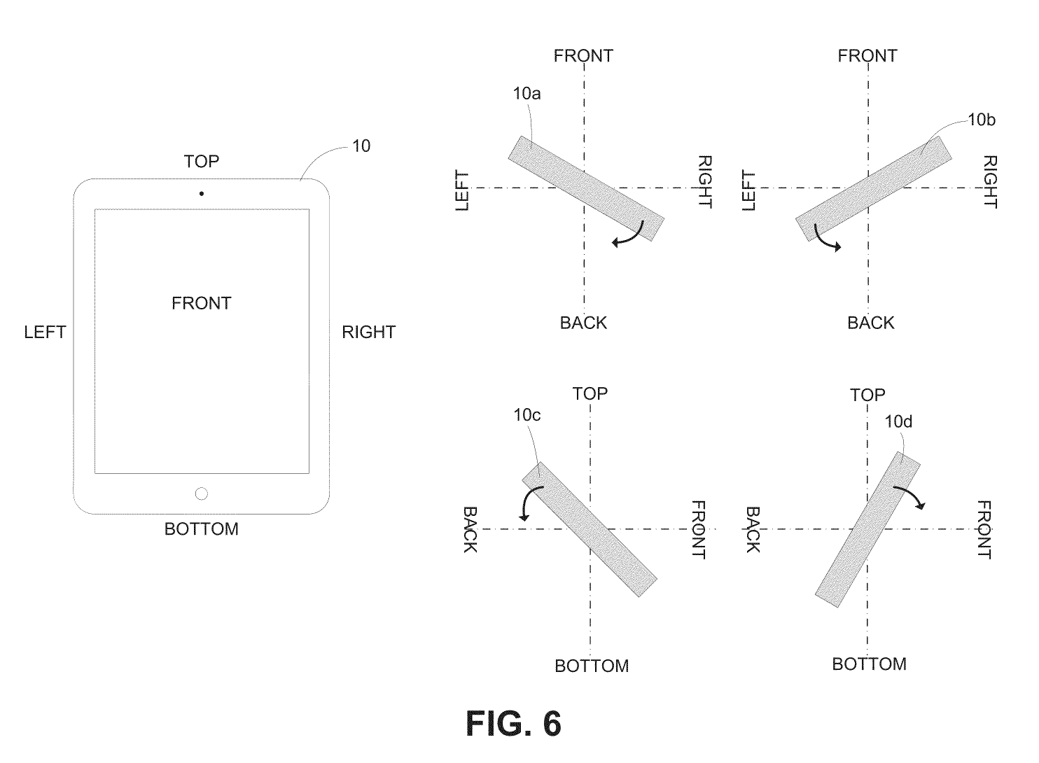

The examples to this point have used the example of shuffling a content library by randomly moving a computing device or an input device to shuffle the content library. However, it will be understood that numerous different input actions, input devices, and interactive operations may be performed by applying the present disclosure. In FIG. 6, another motion-based operation is depicted, in which the user can tilt the computing device 10 in a variety of directions to perform a desired operation. One example of such an operation might include filtering the content elements 16 such that certain content elements are filtered out and the remaining, revised content element library consists of a subset of the original content library. Using the example in FIG. 6, the user may be able to tilt the computing device 10 in four different directions, to the right (10a), to the left (10b), backwards (10c), or frontwards (10d). These four different tilting actions may result in a different filter being applied to the electronic content library.

For example, if the content library consists of a plurality of video content files, each of the video content files may be associated with a particular genre, such as drama, action, comedy, or musical. Each of the directional tilting actions may be associated with a particular genre, such that tilting in that particular direction will result in videos outside of the particular genre being removed from the electronic content library. In this particular example, tilting the device to the left may result in only comedy videos being displayed, or tilting the device to the right may result in only action videos being displayed. When a tilting action input is detected by the computing device, an animation may be displayed to indicate that the proper processing is being performed. An example of such an animation might include, upon tilting of the device to the left, all of the content elements sliding to the left and any non-conforming exiting the display, and all content that fits the filter criteria piling up on the left side of the display.

In another example, a plurality of news articles may be displayed in the electronic content library, and each of the four directional tilts may be associated with sports news, entertainment news, international news, and financial news. Tilting to any one of the four directions will result in only those news items which fit the filter criteria remaining on the display. These action/result pairings may be defined by the user to fit the user's particular needs or preferences. Multiple actions may also be combined to alter the content library in multiple ways. For example, using the operations discussed above, a user may first filter the library by genre using a first action input, and then may shuffle the resulting filtered playlist using a second action input.

In addition to the filtering “genre” category discussed above, additional examples of filtering categories might include age categories, review scores, popularity scores, thematic categories, or any other category by which electronic content may be filtered. These filtering categories may be pre-determined categories that are a part of the electronic content, or a user may enter and/or specify the filtering category fields.

The user inputs that have been discussed to this point have been primarily discussed with respect to motion sensors, but it will be appreciated that user action inputs may be provided via different input devices. A touch-sensor may be used to receive particular user touch inputs relating to different operations on the electronic content library. An example might include the user touching the touch sensor and making a swirling motion to randomize a playlist, or swiping in a particular direction or manner to filter the playlist. Or a visual sensor may be used to record user actions visually. For example, a light sensor could be used to register a swirling motion (e.g., reading a light, dark, light, dark pattern as the user's hand moves around the sensor) to shuffle the playlist, or a camera could be used to register different user actions to interact with the electronic content library. An audio sensor, such as a microphone, may be used to accept user commands via voice. These user input devices may be built into the computing device itself. For example, a tablet device might include a gyroscope, a touch-screen, and a camera. User input devices may also be secondary devices that are separate from the computing device and communicate with the computing device via wired or wireless communication.

As was discussed above, user action input and library operation pairings may be customized by users according to their personal needs and preferences. In a particular embodiment of the present disclosure, it is contemplated that different users may store their individual preferences on the same computing device and that the appropriate preference settings would be loaded by identifying the user. This may be implemented in various ways using the different user input devices on the computing device. For example, a touch screen or keyboard may be used to enter a username and password, and the identified user's preferences would be loaded into the computing device. In another embodiment, biometric identifiers of the user may be used to identify the user. For example, a visual sensor may be used to identify a user's face or fingerprint, or a touch or visual sensor may be used to identify a user's hand size, or an audio sensor may be used to identify a particular user's voice. By identifying the user, the computing device is able to load up that particular user's preference settings which may include data relating to particular user action inputs and the corresponding operations performed on the electronic content playlist. Additionally, user identification may also be used to apply certain privacy or content-restriction settings, for example, preventing younger users from accessing age-inappropriate content. Alternatively, if the user is a new user or a guest user, then a default set of user action inputs and corresponding playlist operations may be applied.

While various embodiments of the present disclosed systems and methods have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be used to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed systems or methods, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Although the disclosure has been presented with reference only to the presently preferred embodiments, those of ordinary skill in the art will appreciate that various modifications can be made without departing from this disclosure. Accordingly, this disclosure is defined only by the following claims.

1. A method for interacting with an electronic content library comprising:
displaying on a display at least a portion of the electronic content contained in the electronic content library;
receiving via a user input device a user action as an input;
performing a corresponding operation on the electronic content library based on the user action input to yield a revised electronic content library; and
displaying the revised electronic content library on the display.

2. The method of claim 1, wherein the revised electronic content library comprises a shuffled electronic content library in which the order of the electronic content in the electronic content library is changed.

3. The method of claim 1, wherein the user input device comprises a motion sensor.

4. The method of claim 3, wherein the motion sensor comprises a gyroscope.

5. The method of claim 3, wherein the motion sensor comprises an accelerometer.

6. The method of claim 3, wherein when the user action received as an input comprises a shaking action, the corresponding operation performed on the electronic content library is a shuffling operation such that the revised electronic content library displayed on the display is a shuffled electronic content library.

7. The method of claim 3, wherein when the user action received as an input comprises a directional tilting action in a pre-determined direction, the corresponding operation performed on the electronic content library is a filtering operation such that the revised electronic content library displayed on the display is a filtered subset of the electronic content library.

8. The method of claim 1, wherein the user input device comprises a touch sensor.

9. The method of claim 8, wherein the touch sensor comprises a touch-sensitive surface.

10. The method of claim 9, wherein the touch-sensitive surface is the display.

11. The method of claim 8, wherein when the user action received as an input comprises a swirling motion on the touch sensor, the corresponding operation performed on the electronic content library is a shuffling operation such that the revised electronic content library displayed on the display is a shuffled electronic content library.

12. The method of claim 8, wherein when the user action received as an input comprises a directional swipe in a predetermined direction, the corresponding operation performed on the electronic content library is a filtering operation such that the revised electronic content library displayed on the display is a filtered subset of the electronic content library.

13. The method of claim 1, wherein the user input device comprises a visual sensor.

14. The method of claim 13, wherein the visual sensor comprises a light sensor.

15. The method of claim 13, wherein the visual sensor comprises a camera.

16. The method of claim 13, wherein when the user action received as an input comprises a swirling motion captured by the visual sensor, the corresponding operation performed on the electronic content library is a shuffling operation such that the revised electronic content library displayed on the display is a shuffled electronic content library.

17. The method of claim 13, wherein when the user action received as an input comprises a directional swipe in a pre-determined direction, the corresponding operation performed on the electronic content library is a filtering operation such that the revised electronic content library displayed on the display is a filtered subset of the electronic content library.

18. The method of claim 1, wherein the user input device comprises an audio sensor.

19. The method of claim 18, wherein the audio sensor comprises a microphone.

20. A non-transitory computer readable medium comprising an instruction set configured to cause a computing device to perform:
displaying on a display at least a portion of an the electronic content library;
receiving via a user input device a user action as an input;
performing a corresponding operation on the electronic content library based on the user action input to yield a revised electronic content library; and
displaying the revised electronic content library on the display.

21. The non-transitory computer readable medium of claim 20, wherein the user input device comprises a motion sensor.

22. The non-transitory computer readable medium of claim 21, wherein the motion sensor comprises a gyroscope.

23. The non-transitory computer readable medium of claim 21, wherein the motion sensor comprises an accelerometer.

24. The non-transitory computer readable medium of claim 21, wherein when the user action received as an input comprises a shaking action, the corresponding operation performed on the electronic content library is a shuffling operation such that the revised electronic content library displayed on the display is a shuffled electronic content library.

25. The non-transitory computer readable medium of claim 21, wherein when the user action received as an input comprises a directional tilting action in a pre-determined direction, the corresponding operation performed on the electronic content library is a filtering operation such that the revised electronic content library displayed on the display is a filtered subset of the electronic content library.

26. The non-transitory computer readable medium of claim 20, wherein the user input device comprises a touch sensor.

27. The non-transitory computer readable medium of claim 26, wherein the touch sensor comprises a touch-sensitive surface.

28. The non-transitory computer readable medium of claim 27, wherein the touch-sensitive surface is the display.

29. The non-transitory computer readable medium of claim 26, wherein when the user action received as an input comprises a swirling motion on the touch sensor, the corresponding operation performed on the electronic content library is a shuffling operation such that the revised electronic content library displayed on the display is a shuffled electronic content library.

30. The non-transitory computer readable medium of claim 26, wherein when the user action received as an input comprises a directional swipe in a predetermined direction, the corresponding operation performed on the electronic content library is a filtering operation such that the revised electronic content library displayed on the display is a filtered subset of the electronic content library.

31. The non-transitory computer readable medium of claim 20, wherein the user input device comprises a visual sensor.

32. The non-transitory computer readable medium of claim 31, wherein the visual sensor comprises a light sensor.

33. The non-transitory computer readable medium of claim 31, wherein the visual sensor comprises a camera.

34. The non-transitory computer readable medium of claim 31, wherein when the user action received as an input comprises a swirling motion captured by the visual sensor, the corresponding operation performed on the electronic content library is a shuffling operation such that the revised electronic content library displayed on the display is a shuffled electronic content library.

35. The non-transitory computer readable medium of claim 31, wherein when the user action received as an input comprises a directional swipe in a pre-determined direction, the corresponding operation performed on the electronic content library is a filtering operation such that the revised electronic content library displayed on the display is a filtered subset of the electronic content library.

36. The non-transitory computer readable medium of claim 20, wherein the user input device comprises an audio sensor.

37. The non-transitory computer readable medium of claim 36, wherein the audio sensor comprises a microphone.

38. An electronic content interaction system comprising:
a display;
an action input device; and
a memory storing
an electronic content library and
user action input interaction information, wherein
when the display is displaying at least a portion of the electronic content library, a user may perform an action using the action input device to interact with the electronic content library,
and further wherein
the user action input interaction information stored on the memory comprises information relating particular actions to particular operations such that a particular action performed on the action input device results in a pre-determined interaction with the electronic content library, the pre-determined interaction with the electronic content library resulting in display of a revised electronic content library on the display.
